(19) United States
(12) Patent Application Publication
(10) Pub. No.: US 2016/0189730 A1
(43) Pub. Date: Jun. 30, 2016

(54) SPEECH SEPARATION METHOD AND SYSTEM

(71) Applicants: IFLYTEK CO., LTD., Hefei City (CN); UNIVERSITY OF SCIENCE AND TECHNOLOGY OF CHINA, Hefei City (CN)

(72) Inventors: Jun DU, Hefei City (CN); Yong XU, Hefei City (CN); Yanhui TU, Hefei City (CN); Li-Rong DAI, Hefei City (CN); Zhiguo WANG, Hefei City (CN); Yu HU, Hefei City (CN); Qingfeng LIU, Hefei City (CN)

(73) Assignees: IFLYTEK CO., LTD.; UNIVERSITY OF SCIENCE AND TECHNOLOGY OF CHINA

(21) Appl. No.: 14/585,582

(22) Filed: Dec. 30, 2014

(51) Int. Cl. G10L 21/0272

(52) U.S. Cl. CPC G10L 21/0272

(57) ABSTRACT

An example of the present invention discloses a speech separation method and a system, the method comprises: receiving a mixture speech signal to be separated; extracting a speech feature of the mixture speech signal; inputting the extracted speech feature of the mixture speech signal into a regression model for speech separation, obtaining an estimated speech feature of a target speech signal; synthesizing to obtain the target speech signal according to the estimated speech feature. Speech separation effect can be improved effectively using the present invention.

### TECHNICAL FIELD

The present invention is directed to a technical field of speech processing, specifically to a speech separation method and a system.

### BACKGROUND ART

In recent years, communication manner of human to human and human to machine has been changed dramatically along with enhancement of function of intelligent terminals, improvement of cloud calculation ability and development of wireless communication network. Speech, as the most important, most common and most convenient information exchange manner, is naturally an indispensable medium. However, at the time of acquiring speech, background noise, interference and reverberation all affect speech quality, which not only reduces speech intelligibility and sound of speech, but also causes difficulties to subsequent treatment, such as speech recognition.

Speech enhancement is to restore as much as possible initial pure speech signal starting from removing various interferences as a primary point. There are different speech enhancement methods with respect to different type of interferences. Speech separation technology for removing speech interference is an important branch in the field of speech enhancement study currently.

In recent years, many researchers have studied trying to apply neural network to speech separation as research on neural network has made prominent progress, such as on the basis of shallow neural network, on the basis of deep neural network estimating ideal binary mask, on the basis of denoising auto-encoders, etc. However, there are still many problems in the current neural network based speech separation method such as speech information distortion, unsatisfactory modeling of neural network model, etc. caused by insufficient training data, too simple of neural network model structure, unreasonable initiation of model parameters, too many impractical hypotheses and so on.

### SUMMARY OF THE INVENTION

Some examples of the present invention provide a speech separation method and a system for solving problems of speech information distortion and unsatisfactory modeling of neural network model in the traditional speech separation method, and improving effect of speech separation.

Hence, some examples of the present invention provide the following technical solution:

A speech separation method, comprising:

receiving a mixture speech signal to be separated;

extracting a speech feature of the mixture speech signal;

inputting the extracted speech feature of the mixture speech signal into a regression model for speech separation, obtaining an estimated speech feature of a target speech signal;

synthesizing to obtain the target speech signal according to the estimated speech feature.

A speech separation system, comprising:

a receiving module, for receiving a mixture speech signal to be separated;

a feature extracting module, for extracting a speech feature of the mixture speech signal received by the receiving module;

a speech feature separating module, for inputting the speech feature of the mixture speech signal extracted by the feature extracting module into a regression model for speech separation, obtaining an estimated speech feature of a target speech signal;

a synthesizing module, for synthesizing to obtain the target speech signal according to an estimated speech feature outputted by the speech feature separating module.

A computer readable storage medium, comprising computer program code, the computer program code is executed by a computer unit, so that the computer unit:

receiving a mixture speech signal to be separated;

extracting a speech feature of the mixture speech signal;

inputting the extracted speech feature of the mixture speech signal into a regression model for speech separation, obtaining an estimated speech features of a target speech signal;

synthesizing to obtain the target speech signal according to the estimated speech feature.

The speech separation method and system provided by one or more examples of the present invention use a regression model that can fully reflect relationship between a speech feature of a single target speech signal and a speech feature of a mixture speech signal comprising the target speech to obtain an estimated speech feature of a target signal when speech separation, and thus synthesizing to obtain a target speech signal according to the estimated speech feature. The speech enhancement method and system of one or more examples of the present invention solve problems such as speech information distortion, unsatisfactory modeling of neural network model, etc. caused by too simple of neural network model structure, unreasonable initiation of model parameters, too many impractical hypotheses and so on in the traditional speech separation method, and significantly improve effect of speech separation.

### BRIEF DESCRIPTION OF THE DRAWINGS

In order to explain technical solution in the example of the present application or prior art more clearly, the following gives simply introduction of figures need to be used in the example. It is obvious that the figures in the description below are merely examples recorded in the present invention, and those skilled in the art may obtain other figures based on these figures.

FIG. 1 shows a flow diagram of a speech separation method according to one example of the present invention;

FIG. 2 shows a structuring flow diagram of a regression model according to one example of the present invention;

FIG. 3 shows a model structuring schematic diagram of RBM according to one example of the present invention;

FIG. 4A shows a structure frame of a speech separation system according to one example of the present invention;

FIG. 4B shows another structure frame of a speech separation system according to one example of the present invention;

FIG. 5 shows a structure frame of a model structuring module according to one example of the present invention;

FIG. 6 shows a principle frame of training of a regression model of distinguishing SNR (signal to noise ratio) and implementing speech separation.

### DETAILED DESCRIPTION

The example of the present invention is further illustrated in detail with combination of figures and embodiments in order that those skilled in the art can better understand solutions of the present invention.

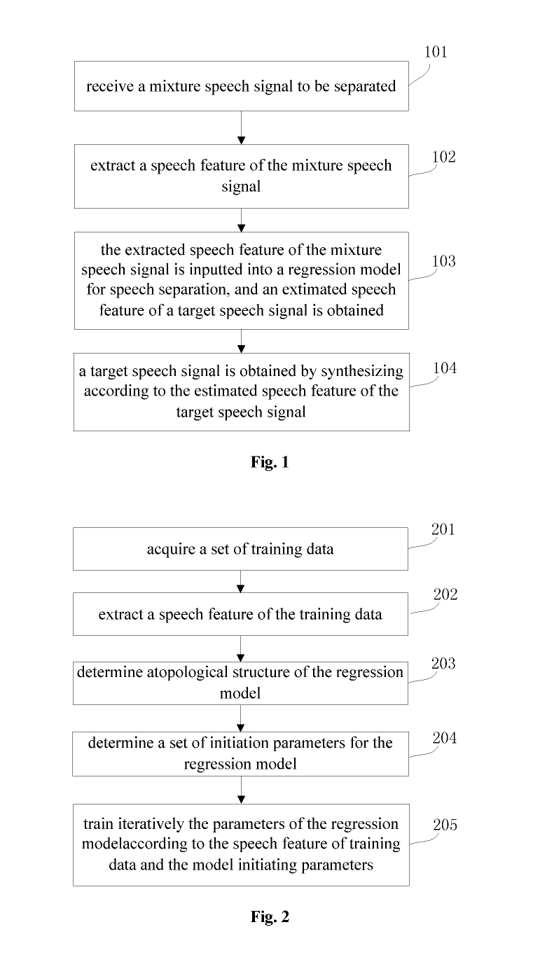

Shown in FIG. 1 is a flow diagram of a speech separation method according to one example of the present invention, which comprises the following steps:

Step 101, to receive a mixture speech signal to be separated.

The mixture speech signal to be separated may be a noisy speech signal, and may also be a multi-speaker speech signal with speech of a target speaker.

Step 102, to extract a speech feature of the mixture speech signal.

Particularly, the speech signal is subjected to treatment of windowing framing at the first, and then the speech feature is extracted. In one example of the present invention, the speech feature may be a logarithmic power spectrum feature with comparatively comprehensive information, and of cause other features such as Mel Frequency Cepstrum Coefficient, Perceptual Linear Predictive Coefficient, Linear Predictive Coefficient, power spectrum feature, etc. may also be included.

For example, in practical application, window function of 32 ms can be used for speech framing, sampling frequency is 8 KHz, and logarithmic power spectrum feature of 129 dimension is extracted.

Step 103, the extracted speech feature of the mixture speech signal is inputted into a regression model for speech separation, and an estimated speech feature of a target speech signal is obtained.

The regression model reflects a relationship between a speech feature of single target speech signal and a speech feature of mixture speech signal comprising the target speech, specifically, network model such as Deep Neural Network (DNN), recurrent neural network, (RNN), Convolutional Neural Networks (CNN), etc. can be used. The regression model can be structured in advance, and the specific structuring procedure will be discussed in detail in the following content.

In practical application, the speech feature of speech data of current frame and 5 frames of left and right is inputted at the one time with consideration of context information of the speech, that is, the speech feature of speech data of 11 frames is inputted at the one time. For example, for speech separation of a noisy speech signal, logarithmic power spectrum feature of 11 frame speech data is inputted to the regression model at the one time, and a outputted 129 dimensional speech logarithmic power spectrum feature of a pure speech is obtained.

Step 104, a target speech signal is obtained by synthesizing according to the estimated speech feature of the target speech signal.

The following formula is used to transform pure speech logarithmic power spectrum feature to a pure speech signal:

\hat{X}^{f}(d)=exp{\hat{X}¹(d)/2} exp {j∠Y^{f}(d)} (1)

wherein, \hat{X}^{f}(d), denotes a pure speech frequency signal, \hat{X}¹(d) denotes pure speech logarithmic power spectrum, ∠Y^{f}(d) denotes a phase of a noisy speech at number d frequency point,

$${∠ Y}^{f} ( d ) = arctan ( \frac{imag ( {Y}^{f} * ( d ) )}{real ( {Y}^{f} ( d ) )} ) ,$$

imag(Y^{f}(d)) is the imaginary part of the noisy speech frequency signal, and real(Y^{f}(d)) is the real part of the noisy speech frequency signal.

The reason that the phase of the pure speech still uses the phase of the noisy speech is that human ear is not sensitive to a phase.

Shown in FIG. 2 is a flow diagram of structuring a regression model according to one example of the present invention, which comprises the following steps:

Step 201, to acquire a set of training data.

In practical application, training data of a regression model can be acquired according to a practical application case.

For speech separation for the purpose of noise reduction, i.e., separating pure speech from noisy speech, the acquired training data are noisy speech data, the noisy speech data and the pure speech data can be acquired through recording. Specifically, there can have two megaphones in an environment of recording room, one broadcasts clean speech and another one broadcasts noisy, and then re-records noisy speech with a microphone, when training, it is acceptable that the re-recorded noisy speech and the corresponding clean speech are in frame synchronization. The noisy speech data are also available through obtaining parallel speech data by adding noisy to pure speech, the parallel speech data refers to that noisy speech obtained through artificially adding noise and clean speech are completely correspond at frame level, the recovery of noise and size of data can be determined according to the practical application context, if for a particular application context, the noise needs to be added is a seldom type of noise that may possibly appear under the application context; and for general application, the more the type of noises covered and the more comprehensive, the better the effect. Therefore, when adding noise, the better the more comprehensive of the type of noises and the SNRs.

For example, noise sample can be Gaussian white noise, multi-speaker noise, restaurant noise, street noise, etc. selected from Aurora2 database. The SNR can be: 20 dB, 15 dB, 10 dB, 5 dB, 0 dB, −5 dB, etc. Pure speech and noise are added up to stimulate size of relative energy of speech and noisy in the practical context, and thus forming training set of various environment types and sufficient time length (for example about 100 hour) to ensure generalization ability of the model.

For speech separation for the purpose of separating multiple speech, i.e., to separate speech of a target speaker from multi-speaker speech, also with respect to speech of a target speaker and speech of multi-speaker for model training, multi-speaker mixture speech comprising speech of the target speaker can be obtained through recording or adding speech of non-target speaker to speech of the target speaker.

For example, multi-speaker pure speech data can be selected from Speech Separation Challenge (SSC), which includes 34 speakers (18 man speakers and 16 female speakers), each speaks 500 sentences with each sentence lasts about 1 second (about 7 English words). To each target speaker, 10 out of 33 speakers exclusive of the target speaker are selected optionally as interfering speakers, pure speech and interference are added up according to different SNRs: 10 dB, 9 dB, 8 dB . . . −8 dB, −9 dB, −10 dB to stimulate size of relative energy of the target speaker and interfering speakers in the practical context, and thus forming training set of about 100 hours to ensure generalization ability of model.

Step 202, to extract a speech feature of the training data.

The speech feature of the training data can be Mel Frequency Cepstrum Coefficient (MFCC), Linear Predictive Coding (PLP), the power spectrum feature, the logarithmic power spectrum feature, etc. Taking the logarithmic power spectrum feature as an example, the feature dimension is determined by sampling frequency of speech, for instance, if sampling rate of speech is 8 KHZ, then a 129 dimensional logarithmic power spectrum feature is extracted.

Since in the logarithmic power spectrum domain, a relation between noise and speech is comparatively clear, and perception of human ear to speech is in logarithmic relation, the above speech feature can select the logarithmic power spectrum of comparatively comprehensive information, of cause other features such as Mel Frequency Cepstrum Coefficient, perception Linear Prediction, Linear Predictive Coefficient, the Power Spectrum feature, etc. serve the role of supplement to thereof.

Specific extracting procedure of the logarithmic power spectrum feature is as below:

1. Firstly the short-time Fourier transform:

Y^{f}(d)=Σₖ₌₀^{K-1}Y^{t}(k)H(k)e^{j2πk/K} d=0, 1, . . . , K−1 (2)

wherein, Y^{t}(k) denotes the sample of the number k noisy speech; Y^{f}(d) denotes the frequency spectrum of noisy speech of number d dimension; K denotes the point of Discrete Fourier Transform (DFT) , for instance, if sampling rate is 8 kHz, taking 256 DFT points; H(k) denotes window function, and Hamming window can be used.

1. Extracting the logarithmic power spectrum feature, the formula is as below:

Y¹(d)=log|Y^{f}(d)|² d=0, 1, . . . , D−1 (3)

wherein D=K/2+1, i.e., the dimension of the logarithmic power spectrum feature, and which can be determined according to requirement specifically, for instance, it is acceptable that D=129, because of symmetry of DFT, then k=D, D+1, K−1, Y¹(d)=Y¹(K−d).

Step 203, to determine a topological structure of the regression model.

The topological structure of the regression model comprises an input layer, an output layer and several hidden layers; input vectors of the input layer include the speech feature, or include the speech feature and noise estimation, output vectors of the output layer include a target speech feature, or include the target speech feature and a non-target speech feature. Determination of these structure parameters can be on the basis of practical application, for instance: to have 129×11 input notes, 3 hidden layers, 2048 hidden layer nodes, and 129 output nodes.

In practical application, 5 frames can be extended at left and right of the input layer, which can better ensure that the inputted context information is sufficiently rich, and multi-frame input also ensures reinforced speech continuity.

Below is detailed explanation of each layer of the regression model.

Input layer: numbers of input nodes is determined according to the dimension of the feature extracted by training data and frames of inputted speech data, for instance, the speech feature is a 129 dimensional logarithmic power spectrum feature, and the input vectors are the feature of 11 frames speech data with consideration of 5 frames of left and right, then the number of input notes is 1419=129×11. In addition, the input vectors also can include information for extra description of the input feature, the information can be:(1) estimation of noise, which is to describe general situation of noisy environment where the current sentence is in; and (2) other speech features, such as MFCC, PLP, etc., since there is supplementary among different speech features.

Estimation of noise is as below:

$${\hat{Z}}_{n} = \frac{1}{T} {\sum }_{t = 1}^{T} {Y}^{t} \qquad ( 4 )$$

wherein Y^{t} is the initial noisy speech signal, indicating that an average value of prior T frames of the current sentence is used as noise estimation of the sentence. T can be 6, since the first 6 frames are generally non-speech frames.

Hidden layer: numbers of hidden layer and number of nodes of hidden layer can be determined according to experience or the practical application situation, such as that the number of hidden layer is 3, and the number of node of hidden layer is 2048.

Output layer: output vectors can be a pure target speech feature, or a target speech feature and non-target speech feature can also be outputted together, so that the target speech feature is more accurate. For example, it can be outputted the power spectrum feature of the target speech, and also the power spectrum feature of non-target speech at the same time. The number of output nodes is 258=129×2, corresponding to the logarithmic power spectrum feature of the two outputs respectively. In addition, the output vectors also can include other speech features, such as MFCC, PLP, etc.

Adding the output of non-target speech feature can be as regularization item of target function for better facilitating prediction of the target speech power spectrum. With each one more output vector, more information about the target speech can be obtained since outputted information of non-target speech is equivalent to interference information of the target speech, and thus the regression model can predict the target speech more accurately.

Step 204, to determine a set of initiation parameters for the regression model.

Specifically, the initiating parameters can be set according to experience, and then to fine tune the model directly according to feature of training data, there can have several training criteria and training algorithms, no one is defined as a particular method, for instance: training criteria include minimum mean-square error, maximum posterior probability, etc. The training algorithm can be gradient descent, momentum gradient descent, variable learning rate, etc.

Of cause, the initiation parameters of the model can also be determined using unsupervised training based on Restricted Boltzmann Machines (RBM), and then the model parameters can be fine-tuned in a supervised way.

FIG. 3 shows a model structure of RBM, which is a double-layered optional neural network, joint probability of RBM can be defined as:

$$p ( v , h ) = \frac{1}{Z} exp \{ - E ( v , h ) \} \qquad ( 5 )$$

wherein v , h is input layer variable and hidden layer variable of RBM, respectively, Z=Σₕ∫ᵥ^{e}^{^{E(v,h)}}dv is a partition function, E is an energy function:

$$E ( v , h ) = {( v - a )}^{T} {\sum }^{- 1} ( v - a ) - {h}^{T} b = {( {{\sum }^{-}}^{\frac{1}{2}} v )}^{T} Wh \qquad ( 6 )$$

wherein, a is bias of v, b is bias of h, and W is the weight connecting v and b.

A training criteria of the model is to make the model converge to a stable state with the lowest energy, which is to have a maximum likelihood corresponding to the probability model. Model parameters of RBM can be obtained with high efficiency through training by minimum Contrastive Divergence (CD) algorithm.

In pre-training procedure, the input of the next RBM is the output of the previous RBM, when pre-training is completed, each RBM can be stacked for the supervised training in next step.

Step 205, to train iteratively the parameters of the regression model according to the speech feature of training data and the model initiating parameters.

There can have several training criteria and training algorithm of the model training, for instance, training criteria comprise minimum mean-square error, and maximum posterior probability. Training algorithm comprises gradient descent, momentum gradient descent, variable learning rate, etc. The example of the present invention does not limit any particular method, which can be determined according to the related application requirement.

For example, a minimum mean-square error algorithm (MMSE) can be used to tune model parameters under supervision and complete model training, then model parameters updating the target function is as below:

$$E = \frac{1}{N} {\sum }_{n = 1}^{N} {\sum }_{d = 1}^{D} {( \frac{log ( {\hat{X}}_{n}^{d} ( {W}^{l} , {b}^{l} ) ) - gm}{gv} - \frac{log ( {X}_{n}^{d} ) - gm}{gv} )}^{2} \qquad ( 7 )$$

wherein, E is error of mean square, \hat{X}ₙ^{d}(W^{l}, b^{l}) and Xₙ^{d} each denotes the power spectrum of the enhanced signal at d-th frequency point of number n sample and the power spectrum of reference signal. gm and gv are the global mean and variance of the logarithmic power spectrum feature calculated from noisy speech in entire training set, and are used for gaussian normalization of speech feature of training data. N is the size of min-batch, D is the feature dimension. (W^{l}, b^{l}) denotes weight and bias item of neural network at the l layer. The updating thereof is as below:

$$( {W}^{l} , {b}^{l} ) ← ( {W}^{l} , {b}^{l} ) - λ \frac{\partial E}{\partial ( {W}^{l} , {b}^{l} )} , \\ 1 \leq l \leq L + 1 \qquad ( 8 )$$

wherein, L denotes numbers of hidden layer, and λ denotes the learning rate.

It should be noted that training study of a regression model is not completely similar to brain learning of humans, for instance adding some extreme adverse examples to training data may decrease performance of the entire model. Therefore, multiple regression models can be trained according to different SNRs, i.e., to structure regression models corresponding to different SNRs based on classification of SNR of training data, and thus achieving speech separation according to multiple regression models in practical application in order to further improve effect of speech separation.

For example, training the regression model with use of positive negative SNR information, training data are classified according to the SNR of the following two parts: SNR>=zero (0 dB, 1 dB . . . 9 dB, 10 dB) and SNR<=zero (0 dB, −1 dB . . . −9 dB, −10 dB). The two parts of training data are used for training to obtain a regression model corresponding to positive SNR and a regression model corresponding to negative SNR.

Since the SNR of the speech signal to be separated is unknown, it needs to be structured a general regression model without distinguishing SNR of training data in this case as a predictor of SNR. Before separation of the speech signal to be separated with a regression model on the basis of SNR, the predictor of SNR is used for the separation of mixture speech to obtain a target speech and an interference speech, and then calculation to obtain a predicted SNR. If the SNR is greater than zero, a regression model of positive SNR is selected for the separation of the mixture speech, otherwise, a regression model of negative SNR is selected for the separation of the mixture speech.

The speech separation method provided in example of the present invention uses a regression model that can fully reflect relationship between the speech feature of a single target speech signal and the speech feature of a mixture speech signal comprising the target speech to obtain an estimated speech feature of a target speech signal when carrying out speech separation, and further synthesizes to obtain the target speech signal according to the estimated speech feature of the target signal. The speech separation method provided in example of the present invention solves problems such as speech information distortion, unsatisfactory modeling of neural network model, etc. caused by too simple of the neural network model structure, unreasonable initiation of model parameters, too many impractical hypotheses and so on, existed in traditional speech separation methods, and significantly improves speech separation effect.

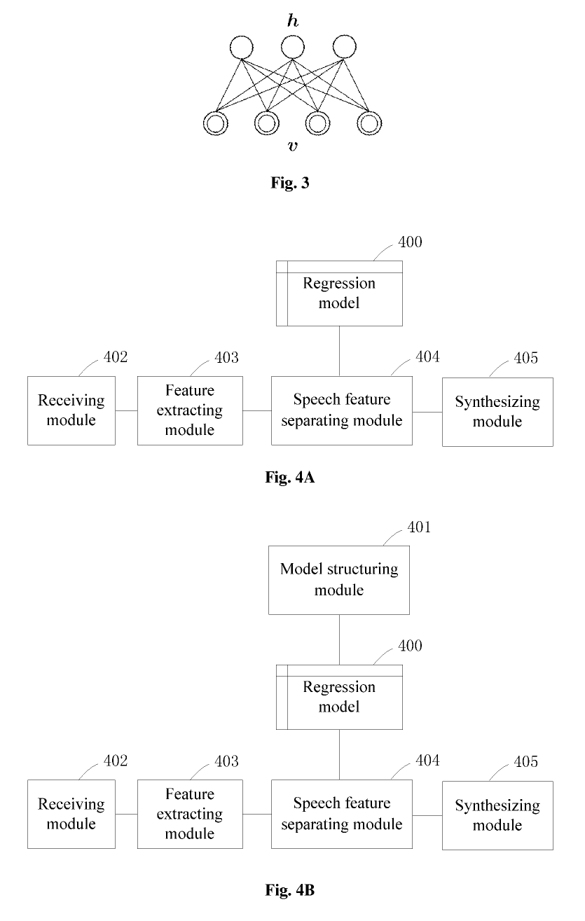

Accordingly, one example of the present invention further provides a speech separation system as shown in FIG. 4A, which is a structure flow diagram of the system.

In the example, the speech separation system comprises:

a receiving module 402, for receiving a mixture speech signal to be separated;

a feature extracting module 403, for extracting a speech feature of the mixture speech signal received by the module 402;

a speech feature separating module 404, for inputting the speech feature of the mixture speech signal extracted by the feature extracting module 403 into a regression model 400 for speech separation, to obtain an estimated speech feature of a target signal;

a synthesizing module 405, for synthesizing to obtain the target speech signal according to the estimated speech feature outputted by the speech feature separating module 404.

The above feature extracting module 403 can be used firstly for treatment such as windowing framing for the speech signal, and then for extracting speech feature. In one example of the present invention, the speech feature can be logarithmic power spectrum feature with comparatively comprehensive information, and of cause other features such as Mel Frequency Cepstrum Coefficient, Perceptual Linear Predictive Coefficient, Linear Predictive Coefficient, power spectrum feature, etc may also be included.

The speech separation system provided in one or more examples of the present invention uses a regression model that can fully reflect relationship between a speech feature of a single target speech signal and a speech feature of mixture speech signal comprising the target speech to obtain an estimated speech feature of a target speech signal when carrying out speech separation, and further synthesizes to obtain a target speech signal according to the estimated speech feature. The speech separation system provided in one or more examples of the present invention solves problems such as voice information distortion, unsatisfactory modeling of neural network model, etc. caused by too simple of neural network model structure, unreasonable initiation of model parameters, too many impractical hypothesis and so on existed in traditional speech separation method, and significantly improves speech separation effect.

In one example of the present invention, the regression model can be pre-structured by other system, and can also be pre-structured by the speech separation system, the example of the present application does not set forth any limit. The other system can be an independent system that only provides structuring function of the regression model, and can also be a module in a system having other functions. Structuring of the regression model needs to be on the basis of large-scaled speech data.

FIG. 4B shows another structure diagram of the speech separation system. Differing from the example shown in FIG. 4A, the speech separation system shown in FIG. 4B further includes a model structuring module 401 for structuring the regression model for speech separation.

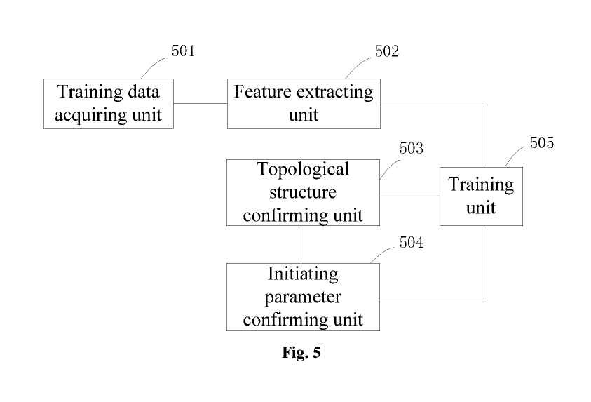

Shown in FIG. 5 is a structure diagram of a model structuring module according to one example of the present invention.

The model structuring module comprises:

a training data acquiring unit 501, for acquiring a set of training data;

a feature extracting unit 502, for extracting a speech feature of the training data acquired by the training data acquiring unit 501;

a topological structure selection unit 503, for determining a topological structure of a regression model, the topological structure of the regression model comprises an input layer, an output layer and several hidden layers; input vectors of the input layer include a speech feature, or a speech feature and noise estimation, output vectors of the output layer include a target speech feature, or include the target speech feature and a non-target speech feature;

a model parameter initialization unit 504, for confirming a set of initialization parameters of the regression model;

a model training unit 505, for training iteratively the parameters of the regression model according to the speech feature of the training data extracted by the feature extracting unit 502 and the model initiating parameters determined by the model parameter initialization unit 504.

It should be noted that the above training data acquiring unit 501 may acquire training data of the regression model according to the practical context, for instance, noisy speech data are acquired for speech separation for purpose of noise reducing, and mixture speech data of multi-speaker comprising target speaker are acquired for speech separation for the purpose of separating multiple speech. Acquiring manner of different type of training data can refer to description about the speech separation method in example of the present invention, no specification is repeated herein.

The speech feature of the training data can be MFCC, PLP, the power spectrum feature, the logarithmic power spectrum feature, etc.

The above model parameter initialization unit 504 can determine model initiating parameters on the basis of unsupervised pre-training of RBM, specifically.

Determining procedure of the model topological structure and initiating parameters may refer to the foregoing description about the speech separation method of the present invention in specific, no details are provided herein.

In one example of the present invention, training criteria of the regression model is to make the model get to a stable state with the lowest energy, which is to have a maximum likelihood when corresponding to the probability model.

The above model training unit 505 can update parameters of model by using Error Back Propagation of minimum mean-square error and the speech feature of extracted training data and complete model training.

In addition, it needs to be stated that training study of the regression model is not completely similar to brain learning of humans, for instance adding some extreme adverse examples to training data may decrease performance of the entire model. Therefore, in practical application, in order to further improve effect of speech separation, model structuring module 401 may train multiple regression models according to different SNRs, that is, to structure regression model corresponding to different SNRs according to classification of SNR of training data, and thus achieving speech separation according to multiple regression models. That is, training regression model corresponding to different SNR, the training data acquisition unit 501 needs to acquire training data of corresponding SNR. Training procedure of the regression model of different SNRs is the same, with only difference in the training data. For example, a regression model corresponding to positive SNR and a regression model corresponding to negative SNR can be obtained by training separately.

Since the SNR of the speech signal to be separated is unknown, model structuring module 401 needs to structure a general regression model without distinguishing SNR of training data in this case as a predictor of SNR.

Before separation of the speech signal to be separated with a regression model on the basis of SNR, the predictor of SNR is used for the separation of a mixture speech to obtain a target speech and an interference speech, and then calculation to obtain predicted SNR. If the SNR is greater than zero, a regression model of positive SNR is selected for the separation of the mixture speech, otherwise, a regression model of negative SNR is selected for the separation of the mixture speech.

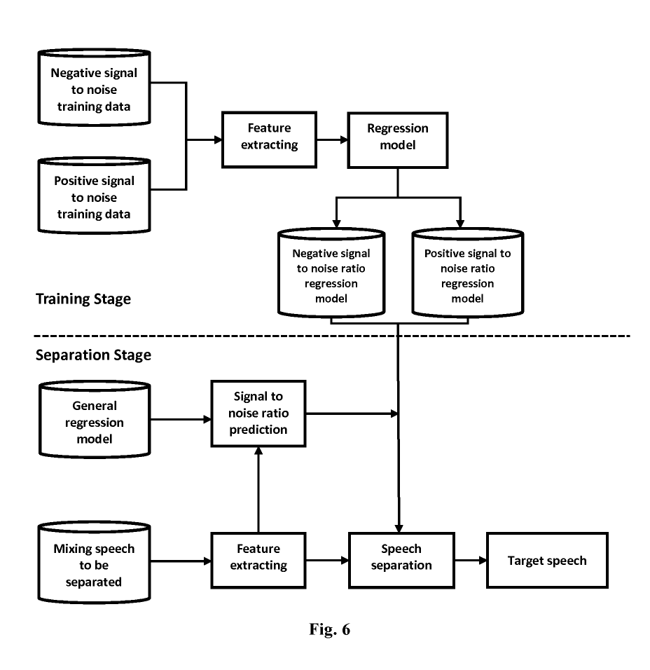

Shown in FIG. 6 is a principle frame of training and implementing speech separation of a regression model of distinguishing SNR.

The speech separation system in the example of the present invention solves problems such as speech information distortion, unsatisfactory modeling of neural network model, etc. caused by too simple of neural network model structure, unreasonable initiation of model parameters, too many impractical hypotheses and so on in the traditional speech separation methods, and significantly improves effect of speech separation.

Each example in the present description is described in a way of going forward one by one, the same and similar part of each example can be referred to each other, and each example is emphasized on its difference from other example. The above described system example is only for illustration, wherein the module stated as separation part can be or can be not physically separated, a part shown as an unit can be or can be not a physical unit, that is, can be positioned on a place, or can be distributed to multiple network units. Some of all the modules can be selected for achieving the purpose of the example of the present application according to practical requirements. And functions provided by some module can be achieved through software, some module can be used together with that having the same function in existing devices (for instance personal computer, tablet computer, mobile phone). Those skilled in the art can understand and implement without involving inventive skills

The above provides detailed explanation about the example of the present invention, the present invention is elaborated by employing specific embodiments in the present description, the explanation for the above example is only for helping understanding the method and device of the present invention; and those skilled in the art may change the specific embodiments and application range based on spirit of the present invention. In summary, the content of the present description should not be understood the limit of the present invention.

What is claimed is:

1. A speech separation method, characterized in the method, comprising:
receiving a mixture speech signal to be separated;
extracting a speech feature of the mixture speech signal;
inputting the extracted speech feature of the mixture speech signal into a regression model for speech separation, obtaining an estimated speech feature of a target speech signal;
synthesizing to obtain the target speech signal according to the estimated speech feature.

2. A method according to claim 1, characterized in the method, further comprising:
structuring in advance the regression model in the following manner:
acquiring a set of training data;
extracting a speech feature of the training data;
determining a topological structure of the regression model; the topological structure of the regression model comprises an input layer, an output layer, a group of hidden layers, input vectors of the input layer include the speech feature, or include the speech feature and noise estimation, output vectors of the output layer include a target speech feature, or include the target speech feature and a non-target speech feature;
determining a set of initialization parameters for the regression model;
training iteratively the parameters of the regression model according to the speech feature of the training data and the model initiating parameters.

3. A method according to claim 2, characterized in the acquiring training data, comprising:
acquiring pairs of clean and noisy speech data for the purpose of noise reduction;
acquiring pairs of multi-speaker mixture speech data and target speaker data for the purpose of separating the speech of the target speaker from the speech of multi-speaker.

4. A method according to claim 3, characterized in the acquiring noisy speech data, comprising:
acquiring a representative set of clean speech data, then adding a large collection of multiple types of noise to the clean speech data, in order to obtain the noisy speech data; or,
acquiring the noisy speech data by stereo recordings.

5. A method according to claim 3, characterized in the acquiring multi-speaker interfering speech data mixed with the target speaker data, comprising:
acquiring speech examples of a target speaker, then adding speech of one or more of the non-target speaker to the speech examples of the target speaker to obtain multi-speaker mixture speech data; or,
acquiring multi-speaker mixture speech data by stereo recordings.

6. A method according to claim 2, characterized in the extracting speech feature of the training data, comprising:
extracting any one or more speech features of the training data: including MFCC, PLP, power spectrum, logarithmic power spectrum.

7. A method according to claim 2, characterized in determining model initialization parameter, comprising:
determining model initialization parameters based on an unsupervised pre-training procedure of a Restricted Boltzmann Machine.

8. A method according to claim 2, characterized in training to obtain a regression model based on the speech features and the initialization parameters of the training data, comprising:
updating parameters of the regression model based on Error Backpropagation of minimum mean-square errors between the intended target and the estimated speech feature for the set of the training data in order to complete model training.

9. A method according to claim 2, characterized in structuring the regression model, comprising:
structuring a general regression model without distinguishing different signal-to-noise ratios of the noisy training data, and
structuring a set of condition-specific regression models each corresponding to a subset of the training set categorized by data under a specified range of signal-to-noise-ratios.

10. A speech separation system, characterized in the system, comprising:
a receiving module, for receiving a mixture speech signal to be separated;
a feature extracting module, for extracting a speech feature of the mixture speech signal received by the receiving module;
a speech feature separating module, for inputting the speech feature of the mixture speech signal extracted by the feature extracting module into a regression model for speech separation, obtaining an estimated speech feature of a target speech signal;
a synthesizing module, for synthesizing to obtain the target speech signal according to the estimated speech feature outputted by the speech feature separating module.

11. A system, according to and characterized in claim 10, further comprising:
a model structuring module for structuring a regression model of speech separation , the model structuring module comprising:
a training data acquisition unit, for acquiring a set of training data;
a feature extracting unit, for extracting a speech feature of the training data acquired by the training data acquisition unit;
a topological structure selection unit, for determining a topological structure of the regression model; the topological structure of the regression model comprises an input layer, an output layer and a group of hidden layers, input vectors of the input layer include the speech feature, or include the speech feature and noise estimation; output vectors of the output layer include a target speech feature, or include the target speech feature and a non-target speech feature;
a model parameter initialization unit, for determining a set of initialization parameters for the regression model;
a model training unit, for training iteratively the parameters of the regression model according to the speech feature of the training data extracted by the feature extracting unit and the model initiating parameters determined by the model parameter initialization unit.

12. A system according to claim 11, characterized in that the training data acquisition unit, comprising specifically for acquiring pairs of clean and noisy speech data for the purpose of noise reduction; for acquiring pairs of multi-speaker mixture speech data and target speaker data for the purpose of separating the speech of the target speaker from the speech of multi-speaker.

13. A system according to claim 11, characterized in that the model parameter initialization module, comprising specifically for determining model initialization parameters based on unsupervised pre-training of regularized RBM.

14. A system according to claim 11, characterized in the model training unit, comprising specifically for updating model parameters based on Error Backpropagation of minimum mean-square errors between the intended target and the estimated speech feature for the set of the training data in order to complete model training.

15. A system according to claim 11, characterized in the model structuring module, for comprising respectively structuring a general regression model without distinguishing different signal-to-noise-ratio of the noisy training data, and structuring a set of condition-specific regression models each corresponding to a subset of the training set categorized by data under a specified range of signal-to-noise-ratios.

16. A computer readable storage medium, comprising computer program code executed by a computer unit, such that the computer unit comprising:
receiving a mixture speech signal to be separated;
extracting a speech feature of the mixture speech signal;
inputting the extracted speech feature of the mixture speech signal into a regression model for speech separation, obtaining an estimated speech feature of a target speech signal; synthesizing to obtain the target speech signal according to the estimated speech feature.
